(19) United States
(12) Patent Application Publication
(10) Pub. No.: US 2013/0016355 A1
(43) Pub. Date: Jan. 17, 2013

(54) Systems and methods for measuring particle concentration

(71) Applicants: Blake Jude Landry, Champaign, IL (US); James Emory Palmer, III, Lafayette, LA (US)

(72) Inventors: Blake Jude Landry, Champaign, IL (US); James Emory Palmer, III, Lafayette, LA (US)

(21) Appl. No.: 13/135,611

(22) Filed: Jul. 11, 2011

(51) Int. Cl. G01N 21/59

(52) U.S. Cl. 356/442

(57) ABSTRACT

A system and method for measuring particle concentration includes a communicative device, a main controller, a photon generator, and a photon sensor. The communicative device is in communication with the main controller. The main controller is in communication with the photon generator and the photon sensor respectively. In operation, the communicative device receives the input data from a user and transmits the input data to the main controller. The main controller decodes the input data. The main controller controls the photon generator to emit a particular type of light at particular intensity represented by the input data. The main controller controls the photon sensor to detect light. Upon detection, the photon sensor measures the amount of photon energy of the detected light and then transmits data representing that amount of photon energy to the main controller. The main controller transmits the data to the communicative device.

### CROSS-REFERENCE TO RELATED APPLICATIONS

Not Applicable.

### BACKGROUND OF THE INVENTION

The present invention generally relates to a system for measuring particle concentration. More particularly, the present invention relates to a system for measuring particle concentration having a main controller that communicates with a photon generator and a photon sensor.

Determining particle concentration in liquid or gaseous media is broadly utilized in different branches of the industry. For instance, researchers and engineers are trying to measure sediment concentration along the seafloor or river bed in order to prevent major flooding problems caused by the formation of sand bars or dune in a river. Other researchers try to measure particle concentration in order to analyze the impact of such concentration on any man-made structure that is placed within the submarine or atmospheric conditions. Moreover, measuring particle concentration may be used in geology field to provide accurate land predictions or a better understanding of coastal dynamics.

One way to measure particle concentration is to use light scattering techniques. This technique normally includes a pair of light emitter and light sensor whereby the light sensor detects light emitted by the light emitter. The particle concentration is measured in proportion to the amount of light reaching the light sensor. For example, a compact particle sensor is disclosed in Unger, U.S. application Ser. No. 12/152,157. The particle sensor in Unger includes a circuit board attached to a laser beam and a photodiode. The sensor also includes a flow passage with an inlet and exit, which allows air to pass through the sensor. The portion of particles which traverse the light beam will scatter light as they pass through the beam and the photodiode will detect the amount of light scattered by the particle. The sensor detects and sizes particle based on the data representing the amount of light detected by the photodiode.

Schneider, U.S. Pat. No. 7,359,055 discloses an optical sensor for determining the concentrations of dye or particles in liquid or gaseous media. The optical sensor includes a measuring head and an evaluating unit. The measuring head is composed of a transmitting element that emits visible light and a receiving element on to which the transmitted light rays that pass through liquid or gaseous medium are guided. The evaluation unit determines particle concentration based on the wavelength of the transmitted light rays. For the purpose of measuring particle concentration in liquid medium, the measuring head is immersed into the liquid medium and the evaluating unit is positioned outside and is connected to the measuring head through wires. The optical sensor may simultaneously determine particle concentration of liquid media at several measuring locations by using one or several measuring heads.

Another example of prior art system using light scattered technique is SediMeter (http ://erlingsson.com/Sedimeter/specifications.html). SediMeter measures turbidity and sediment concentration through the water-bottom interface. SediMeter is a rod-shaped (350 mm length) device which includes infrared light sources and 36 detectors. The system uses infrared back-scattered light from particles to detect concentration. SediMeter has a maximum temporal sampling rate of 5 Hz and a spatial resolution of 0.1 mm.

Bright et al., U.S. application Ser. No. 11/076,729 discloses a photonic sensor system for the detection of a chemical analyte. The system in Bright includes a beta emission source to excite luminophores to generate light. A scintillation layer is optionally interposed between a beta emission source and the plate composed of luminophores. The scintillation material is comprised of a wavelength that the luminophores can absorb and emit, therefore, by choosing an appropriate matching pair of scintillation material and luminophore, the system can emit different wavelengths of light. The sample analyte is placed on the plate of luminophores and when the luminophores absorb the radiation and emits light, the radiation passes through the analyte and reaches the photon detectors. The array-based photon detectors are used to detect the radiation. By comparing the radiation during analyte exposure to the radiation from the radiation unexposed to analyte, the concentration of analyte in a sample can be determined.

### BRIEF SUMMARY OF THE INVENTION

One or more of the embodiments of the present invention provide a system for measuring particle concentration. The system includes a communicative device, a main controller, a photon generator, and a photon sensor. The communicative device is in bidirectional communication with the main controller. The main controller is in unidirectional communication with the photon generator. The main controller is in bidirectional communication with the photon sensor.

In operation, the communicative device receives the input data from a user. The input data represents a sampling rate, a particular type of light and intensity level of light, and the duration of an operating time. The communicative device transmits the input data to the main controller. The main controller receives the input data from the communicative device and decodes the input data. After decoding, the main controller sets a clock cycle in accordance with the sampling rate. The main controller communicates with the photon generator and the photon sensor during each clock cycle for the duration of the operating time.

The main controller transmits a control signal to the photon generator. The control signal represents the type and the intensity of light determined by the main controller. Upon receiving the control signal, the photon generator emits the determined type of light at the determined level of intensity. The photon generator may emit one of any combination of infrared, ultraviolet, and visible light.

The main controller transmits a control signal to the photon sensor. Upon receiving the control signal, the photon sensor controls at least one sensor array to detect light. The sensor array is composed of a plurality of light sensors which measure the amount of photon energy of the detected light. The photon sensor converts the amount of photon energy into data and transmits the data to the main controller.

The main controller receives the data from the photon sensor. The main controller then transmits the data to the communicative device. The communicative device stores the data in a computer-readable medium. Upon the user's request, the communicative device displays the data in a graphical interface.

### BRIEF DESCRIPTION OF THE DRAWINGS

FIG. 1 illustrates a block diagram of a system for measuring particle concentration.

FIG. 2 illustrates a block diagram of the main controller of FIG. 1.

FIG. 3 illustrates a block diagram of the photon generator of FIG. 1.

FIG. 4 illustrates a block diagram of the photon sensor of FIG. 1.

FIG. 5 illustrates a block diagram of a data packet representing the amount of photon energy measured by the photon sensor of FIG. 4.

FIG. 6A illustrates a block diagram of a first alternative embodiment of the photon sensor of FIG. 4.

FIG. 6B illustrates a block diagram of a second alternative embodiment of the photon sensor of FIG. 4.

FIG. 7 illustrates a block diagram of a third alternative embodiment of the photon sensor of FIG. 4.

FIG. 8 illustrates a flowchart of a method for measuring particle concentration.

FIG. 9 illustrates a user interface of control settings for the system for measuring particle concentration of FIG. 1.

FIG. 10 illustrates a plan view of a first particle concentration display.

FIG. 11 illustrates a perspective view of a second particle concentration display.

FIG. 12 illustrates a plan view of a real-time display of particle concentration.

FIG. 13 illustrates a block diagram of an alternative embodiment of the system for measuring particle concentration of FIG. 1.

FIG. 14A illustrates a plan view of a first setting option for the alternative embodiment of the system for measuring particle concentration of FIG. 13.

FIG. 14B illustrates a plan view of a second setting option for the alternative embodiment of the system for measuring particle concentration of FIG. 13.

FIG. 14C illustrates a plan view of a third setting option for the alternative embodiment of the system for measuring particle concentration of FIG. 13.

FIG. 15 illustrates an elevational view of the alternative embodiment of the system of measuring particle concentration of FIG. 13.

### DETAILED DESCRIPTION OF THE INVENTION

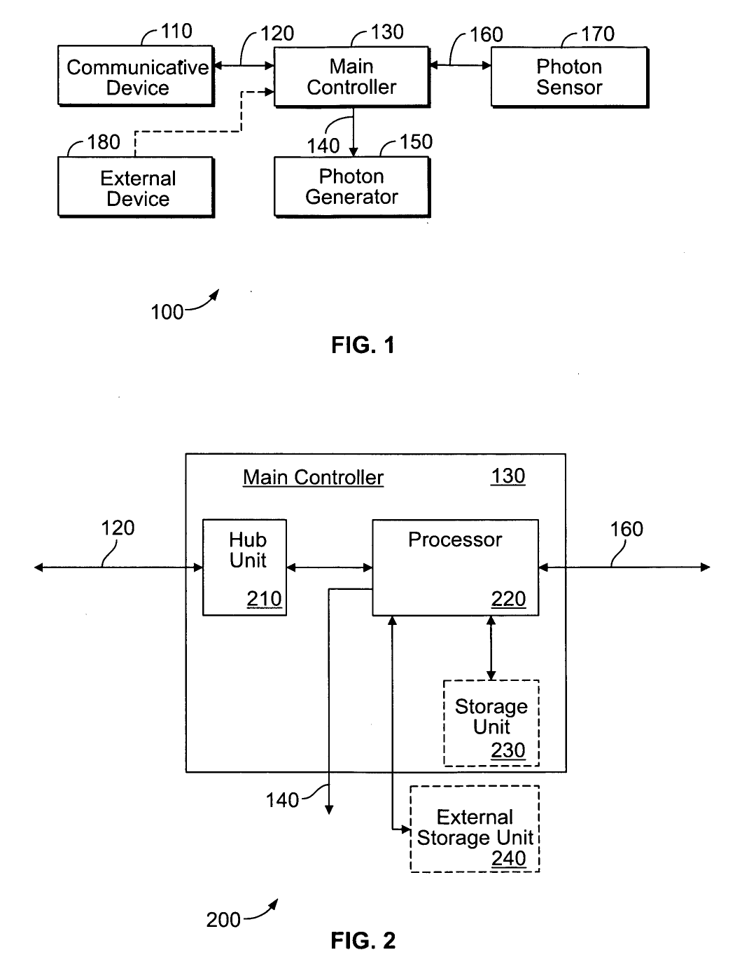

FIG. 1 illustrates a system for measuring particle concentration 100 according to an embodiment of the present invention. The system for measuring particle concentration 100 includes a communicative device 110, a first communicative link 120, a main controller 130, a second communicative link 140, a photon generator 150, a third communicative link 160, and a photon sensor 170.

In the system for measuring particle concentration 100, the communicative device 110 is in bidirectional communication with the main controller 130 connected through the first communicative link 120. The photon generator 150 is in unidirectional communication with the main controller 130 connected through the second communicative link 140. The photon sensor 170 is in bidirectional communication with the main controller 130 connected through the third communicative link 160.

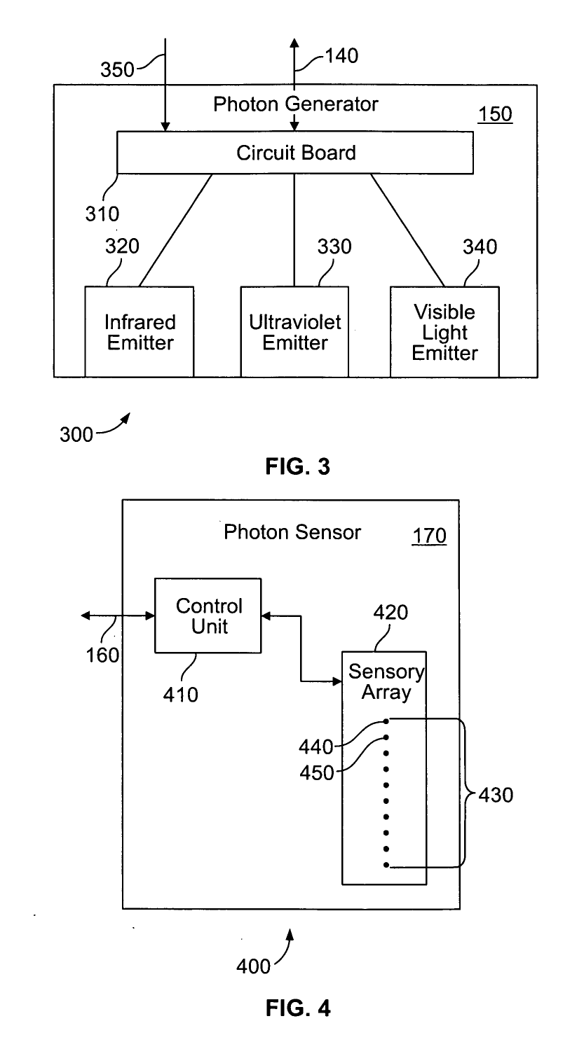

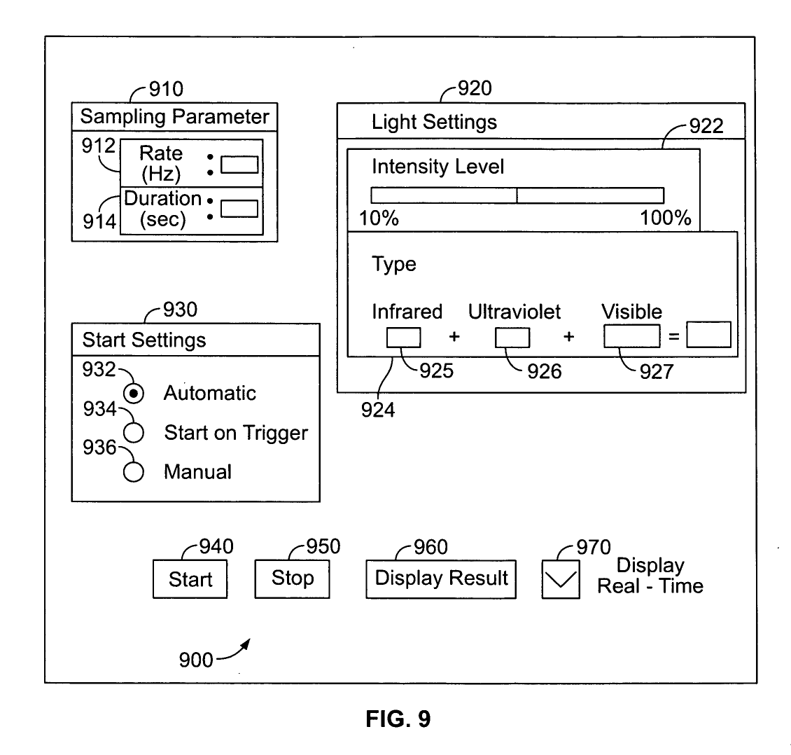

In operation, the communicative device 110 receives an input data from a user. The communicative device 110 is preferably a computer. In the preferred embodiment, the user enters in the input data using the communicative device 110 (as shown below in FIG. 9). Preferably, the input data contains information such as a sampling rate, the duration of an operating time, and light settings. The sampling rate represents a particular sampling rate at which the photon sensor 170 detects light (as shown below in FIG. 4). The duration of the operating time represents a certain period of time during which the system 100 measures particle concentration. The light settings represent a particular type of light and intensity level of light the photon generator emits (as shown below in FIG. 3). In addition, the user may deactivate the system 100 by appropriately manipulating the communicative device 110 (as shown below in FIG. 9).

The input data is transmitted from the communicative device 110 to the main controller 130 through the first communicative link 120. The first communicative link 120 is preferably a USB connection. Upon receiving the input data, the main controller 130 first decodes and interprets the input data. The main controller determines which type of light and at which level of intensity the photon generator 150 emits light based on the information represented by the input data (as shown below in FIG. 2). The main controller also determines at which sampling rate the photon generator 150 emits light (as shown below in FIG. 3) and the photon sensor 170 detects light (as shown below in FIG. 4). Based on the determined sampling rate, the main controller calculates a clock cycle (as shown below in FIG. 2). Finally, the main controller 130 determines the duration of the operating time during which the system 100 is in an active condition measuring particle concentration based on the information represented by the input data.

During each clock cycle, the main controller 130 transmits an activating control signal to the photon generator 150 through the second communicative link 140, which is preferably a three-wire high speed serial bus. Upon receiving the activating control signal, the photon generator 150 emits the determined type of light at the determined level of intensity (as shown below in FIG. 3). The main controller 130 also transmits the activating control signal to the photon sensor 170 through the third communicative link 160 during each clock cycle. The third communicative link 160 is preferably a three-wire high speed serial bus. Preferably, the main controller 130 transmits the activating control signal to the photon generator 150 and the photon sensor 170 simultaneously. The main controller repeats sending the activating control signal to both photon generator 150 and the photon sensor 170 during each clock cycle for the duration of the operating time.

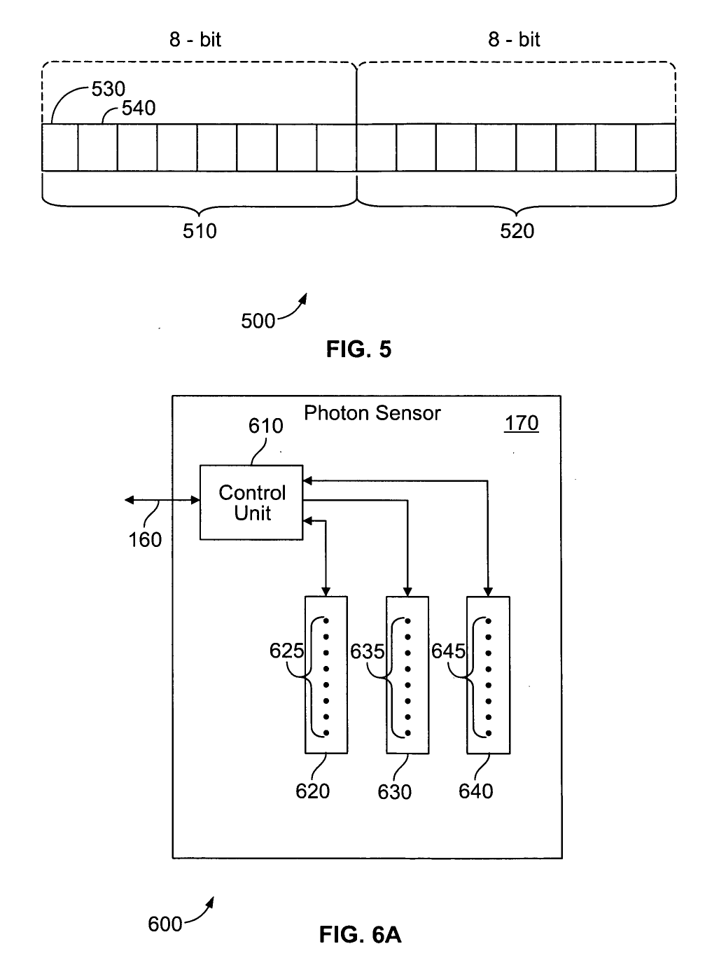

Upon receiving the activating control signal, the photon sensor 170 detects light (as shown below in FIG. 4) at the determined sampling rate. Upon detecting light, the photon sensor 170 measures the amount of photon energy of light detected by the photon sensor 170 and then converts that measurement into data (as shown below in FIG. 5). Preferably, the data represents the amount of photon energy measured by the photon sensor 170. The photon sensor 170 transmits the data to the main controller 130 through the third communicative link 160. After receiving the data from the photon sensor 170, the main controller 130 transmits the data to the communicative device 110 through the first communicative link 120. The communicative device 100 stores the data in a computer-readable medium installed in the communicative device 110. Preferably, the computer-readable medium includes virtual memory, read-only memory (ROM), programmable read-only memory (EPROM), electronically-erasable programmable read-only memory (EEPROM), magnetic media, optical media, a soft disk, a hard disk, and any other type of secondary or tertiary memory.

For the preferred embodiment, the system 100 for measuring particle concentration is used to measure particle concentration of a medium between the photon generator 150 and the photon sensor 170. The medium is preferably either liquid or air. Preferably, the photon generator 150 and the photon sensor 170 are placed apart. As more particles are concentrated in the medium between the photon generator 150 and the photon sensor 170, less light emitted by the photon generator 150 reaches the photon sensor 170, and therefore, the photon sensor 170 measures less amount of photon energy. The system 100 is preferably used to measure and monitor coastal erosion, scour hole formation around bridge piers or pilings; measure concentration of sediment suspended in turbulent eddies generated from ripples, dunes, and/or bars; measure sediment transportation rate; and estimate bed shear stress and initiation of particle motion.

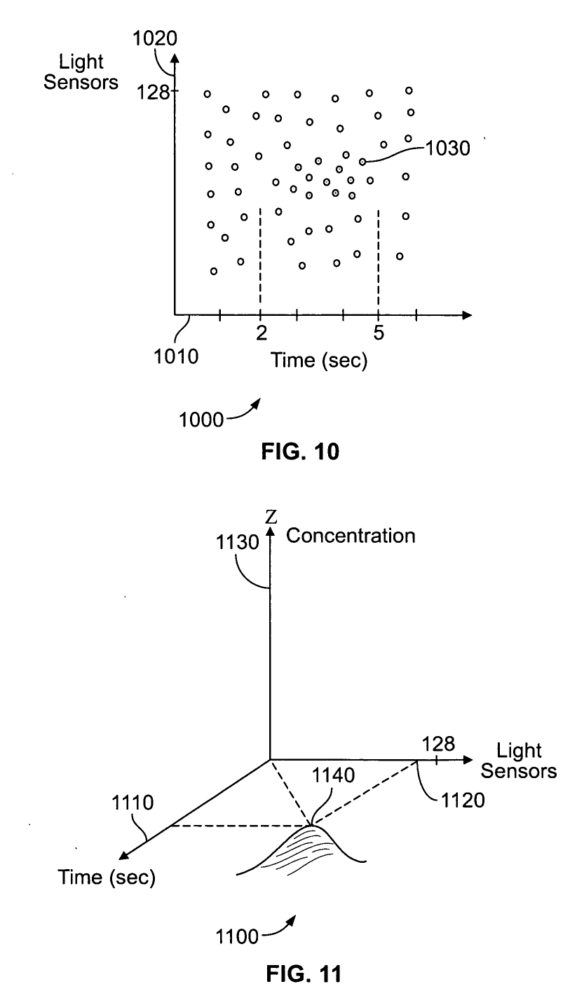

Upon the user's request, the communicative device displays the result of measured particle concentration in a graphical interface using the data stored in its computer-readable medium (as shown below in FIG. 10). Preferably, the communicative device 110 operates a software program which interprets and organizes the data in order to display the result to the user in the graphical interface (as shown below in FIG. 10).

When the user deactivates the system 100 using the communicative device 110 (as shown below in FIG. 9), the communicative device 110 transmits a deactivating signal to the main controller 130 through the first communicative link 120. The main controller 130 then transmits a deactivating control signal to the photon generator 150 through the second communicative link 140 and to the photon sensor 170 through the third communicative link 160. Upon receiving the deactivating control signal, the photon generator 150 terminates emitting light and the photon sensor 170 terminates detecting light respectively. Preferably, the main controller 130 transmits the deactivating control signal to the photon generator 150 and to the photon sensor 170 simultaneously.

In another embodiment, the user may connect an external device 180 to the main controller 130 in order to control the timing of a triggering event. Like the preferred embodiment of the system 100, the input data is transmitted from the communicative device 110 to the main controller 130. The main controller 130, however, does not automatically activate the photon generator 150 and the photon sensor 170 until the main controller 130 receives a separate triggering signal from the external device 180. In this embodiment, the main controller 130 is electrically connected with the external device. The main controller 130 first receives a standby-signal from the external device. Upon receiving the standby-signal, the main controller 130 switches the system 100 to an “armed” mode. In the “armed” mode, the main controller 130 is ready to trigger the system 100 to measure particle concentration. Only when the main controller 130 receives a start-signal from the external device, the main controller 130 transmits the activating control signal to the photon generator 150 and the photon sensor 170 respectively. The main controller 130 then repeats sending the activating control signal during each clock cycle, which is pre-determined by the sampling rate represented in the input data.

In another embodiment, the user may connect the external device 180 to the main controller 130 in order to control a sampling rate. In this embodiment, the external device provides a triggering signal. Instead of relying on the clock cycle calculated based on the sampling rate, the main controller 130 relies on the triggering signal transmitted from the external device 180. Only when the main controller 130 receives the triggering signal from the external device, the main controller 130 transmits the activating control signal to the photon generator 150 and the photon sensor 170 respectively. The main controller 130 then waits for the next triggering signal transmitted from the external device 180.

In another embodiment, the communicative device 110 and the main controller 130 are assembled in a single controlling device. In this embodiment, the user enters the input data into the single controlling device. The single controlling device includes an input device by which the user may enter the input data. The single device includes a display screen or LCD to show the result to the user.

In another embodiment, the main controller 130 is a portable device. In this embodiment, the user may carry the main controller 130.

In another embodiment, the photon generator 150 and the photon sensor 170 are attached to a single circuit board. In this embodiment, the main controller 130 communicates with the circuit board. The circuit board is electrically connected with the photon generator 150 and photon sensor 170.

In another embodiment, the communicative device 110 is any suitable user input device that may communicate with the main controller 130 such as a notepad and smart phone.

In another embodiment, the first communicative link is a wireless communication link.

In another embodiment, the third communicative link is a wireless communication. In this embodiment, the photon sensor 170 includes a transmitter and a receiver to communicate with the main controller 130. The main controller 130 also includes a transmitter and a receiver to communicate with the photon sensor 170.

In another embodiment, the system for measuring particle concentration 100 may be applied to differentiating liquid interface. Even clear water affects light attenuation in a different way than air would. The system is able to measure the differences of light intensity in water, and thus, using various light wavelengths will provide a stable way to discern the interfaces or levels of various fluids.

In another embodiment, the system for measuring particle concentration 100 may be applied to differentiating sediment interface. By adopting a high dense array of light sensors, the system is able to differentiate complex regions of various materials, for example, sand bed from water or clear water from contaminated turbid water.

FIG. 2 illustrates a block diagram of the main controller 130 of FIG. 1. The main controller 130 includes a hub unit 210 and a processor 220.

In the main controller 130, the hub unit 210 is electrically connected with the processor 200. The hub unit 210 is connected with the communicative device 110 of FIG. 1 through the first communicative link 120. The processor 220 is connected with the photon generator 150 of FIG. 1 through the second communicative link 140. The processor 220 is connected with the photon sensor 170 of FIG. 1 through the third communicative link 160.

In operation, when the user enters in the input data, the communicative device 110 of FIG. 1 transmits the input data to the hub unit 210. The preferred embodiment of the hub unit 210 is a USB slave endpoint. The hub unit 210 then transmits the input data to the processor 220. The preferred embodiment of the processor is a Field Programmable Gate Array (FPGA).

After receiving the input data from the hub unit 210, the processor 220 decodes the input data. The processor 220 determines the sampling rate and the duration of the operating time based on the information represented by the input data. The sampling rate represents a particular sampling rate set by the user (as shown below in FIG. 9). The duration of the operating time represents a specific time period during which the system 100 operates to measure particle concentration. The processor 220 then sets a clock cycle based on the determined sampling rate. For example, if the determined sampling rate is 1,000 Hz, the processor 220 sets one clock cycle as 0.001 second. Preferably, the sampling rate may range from 1 to 1,000 Hz. The processor 220 also determines the type of light and intensity level of light the photon generator 150 emits based on the information represented by the input data. Preferably, pulse width modulation method is used for the processor 220 to generate the activating control signal for the photon generator 150.

After decoding the input data, the processor 220 transmits an activating control signal to the photon generator 150 and the photon sensor 170 respectively. The processor 220 transmits the activating control signal to the photon sensor 150 through the second communicative link 140 of FIG. 1. The processor 220 transmits the activating control signal to the photon sensor 170 through the third communicative link 160. Preferably, the processor 220 transmits the activating control signal to the photon generator 150 and the photon sensor 170 simultaneously. The processor 220 repeats transmitting the activating signal to the photon generator 150 and the photon sensor 170 respectively during each clock cycle for the duration of the operating time.

When the user deactivates the system 100, the communicative device 110 of FIG. 1 transmits a deactivating signal to the hub unit 210. The hub unit 210 then transmits the deactivating signal to the processor 220. The processor 220 transmits the deactivating control signal to the photon sensor 150 and the photon sensor 170 respectively.

After the photon sensor 170 detects light and measures photon energy of the detected light, the photon sensor 170 transmits the data to the processor 220. The data represents the amount of photon energy of light detected by the photon sensor 170. The processor 220 transmits the data to the hub unit 210 first. The hub unit 220 then transmits the data to the communicative device 110.

In another embodiment, the processor 220 stores the data in a storage unit 230. Preferably, the storage unit 230 is any computer-readable medium, including virtual memory, read-only memory (ROM), programmable read-only memory (EPROM), electronically-erasable programmable read-only memory (EEPROM), magnetic media, optical media, a soft disk, a hard disk, and any other type of secondary or tertiary memory. In this embodiment, when the user requests the data, the processor 220 retrieves the data from the storage unit 230. The processor 220 then transmits the data to the hub unit 210. The hub unit 210 then transmits the data to the communicative device 110.

In another embodiment, the storage unit 230 is an external memory device 240. In this embodiment, the processor 220 is in bidirectional communication with the external memory device. The processor 220 communicates with the external device to store the data in the external device or to retrieve the data from the external device. When the user requests the data, the processor 220 retrieves the data from the external memory device 240. The processor 220 then transmits the data to the hub unit 210. The hub unit 210 then transmits the data to the communicative device 110.

In another embodiment, after calculating the clock cycle based on the sampling rate represented by the input data, the processor 220 first transmits the activating control signal to the photon generator 150. The processor 220 then waits for a delay time. Preferably, the delay time is less than one clock cycle. After waiting for the delay time, the processor 220 then transmits the activating control signal to the photon sensor 170 through the third communicative link 160 of FIG. 1. In this embodiment, when the processor 220 receives the deactivating signal from the communicative device 110, the processor 220 first transmits the deactivating signal to the photon sensor 170. After transmitting the deactivating control control signal to the photon sensor 170, the processor 220 waits for the delay time. After waiting for the delay time, the processor 220 then transmits the deactivating control signal to the photon generator 150.

In another embodiment, the main controller 130 sets its own sampling rate in random without relying on the input data entered in by the user.

In another embodiment, the main controller 130, without receiving the input data from the user, sets its own sampling rate based on the history record of the sampling rate set by the user. For example, if the user set the sampling rate at 500 Hz previously, the photon sensor 170 automatically sets its own sampling rate at 500 Hz.

In another embodiment, the system 100 does not require the user to set up the duration of the operating time. The main controller 130 repeats transmitting the activating control signal to the photon generator 150 and the photon sensor 170 respectively until the main controller 130 receives the deactivating control signal from the communicative device 110.

FIG. 3 illustrates a block diagram of the photon generator 150 of FIG. 1. The photon generator 150 includes a circuit board 310, an infrared emitter 320, an ultraviolet emitter 330, a visible light emitter 340, and a power line 350.

In the photon generator 150, the circuit board 310 is electrically connected with the infrared emitter 320. The circuit board 310 is electrically connected with the ultraviolet emitter 330. The circuit board 310 is electrically connected with the visible light 340 emitter. The circuit board 310 is electrically connected with the power line 350. The circuit board 310 is connected with the processor 220 of FIG. 2 through the second communicative link 140 of FIG. 1.

In operation, the photon generator 150 is electrically powered by the main controller 130 of FIG. 1. Preferably, the main controller 130 powers the photon generator 150 by providing power through the power line 350. When the processor 220 of FIG. 2 transmits the activating control signal to the photon generator 150, the circuit board 310 receives the activating control signal. Each emitter of the photon generator 150 is activated to emit light based on the information represented by the activating control signal. For example, if the activating control signal transmitted by the processor 220 represents information that the type of light is “infrared” and the intensity level is 50%, the infrared emitter 320 starts to emit infrared at 20% intensity level. For the preferred embodiment, any infrared emitting diodes may be used for the infrared emitter 320, any ultraviolet emitting diodes may be used for the ultraviolet emitter 330, and any visible light emitting diodes may be used for the visible light emitter 340.

When the emitters receive the deactivating control signal from the processor 220 of FIG. 2, the emitters stop emitting light. The emitters then switch into a waiting mode.

In another embodiment, the photon generator 150 may be empowered by a separate supplier. In this embodiment, the power line 350 is connected with the separate power supplier.

In another embodiment, the photon generator 150 may be switched off/on manually by the user.

In another embodiment, any other light emitter which emits light in different wavelengths other than that of infrared, ultraviolet, and visible light may be added to the photon generator 150 or may replace any one of existing three light emitters.

FIG. 4 illustrates a block diagram of the photon sensor 170 of FIG. 1. The photon sensor 170 includes a control unit 410, a sensory array 420, and light sensors 430. The sensory array 420 includes a first light sensor 440 and a second light sensor 450.

In the photon sensor 170, the control unit 410 is electrically connected with the sensory array 420. The sensory array 420 is electronically connected with the light sensors 430. The sensory array 420 is electronically connected with the first light sensor 440 and the second light sensor 450. The control unit 410 is connected with the processor 220 of FIG. 2 through the third communicative link 160 of FIG. 1.

In operation, the control unit 410 receives the activating control signal from the processor 220 of FIG. 2. After receiving the activating control signal, the control unit 410 sends a command signal to the sensory array 420. Preferably, the control unit 410 is a Complex Programmable Logic Device (CPLD). The sensory array 420 then controls the light sensors 430 to detect light. Preferably, the light sensors 430 detect light simultaneously. In one embodiment, the sensory array 420 is an integrated photodiode array. The light sensors 430 are preferably photodiodes. In one embodiment, the sensory array 420 is composed of 128 light sensors. In the preferred embodiment, a center-to-center spacing between each light sensor of the sensory array 420 is less than 1.26 mm. In one embodiment, a spatial resolution for the sensory array 420 is 400 points per inch (0.064 mm). In one embodiment, the light sensors 430 of the sensory array 420 are arranged in a linear array form.

Once all light sensors 430 start to detect light, each light sensor measures the amount of photon energy of the detected light. Preferably, the light sensors 430 generate photocurrent energy that represents certain amount of photon energy. The amount of charge accumulated at each light sensor is directly proportional to the light intensity measured by each light sensor. Preferably, the light sensors 430 generate a voltage on analog output. The voltage output is higher when particles are less concentrated in the medium between the particle generator 150 and particle sensor 170. As the light sensor detects more light, more photon energy is measured. In the preferred embodiment, the light sensors 430 are programmed to generate the voltage output ranging from 0V to 5V, 0V representing no light and 5V representing the most saturated light. The voltage level increases from 0V to 5V in proportion to the intensity of light detected by the light sensors 430.

The sensory array 420 converts the voltage output generated by each light sensor into an electric signal. The sensory array 420 then transmits the electric signal to the control unit 410. The control unit 410 converts the electric signal into a data packet that represents the amount of photon energy measured by each light sensor (as shown below in FIG. 5). The control unit 410 transmits the data packet to the main controller 130 of FIG. 1. Once after the control unit 410 completes transmitting the data packet to the main controller 130, the control unit 410 waits for the next activating control signal transmitting from the processor 220 of FIG. 2. For the preferred embodiment, the photon sensor 170 is encapsulated with epoxy resins or polymethacrylates to be employed in submarine environment.

The control unit 410 repeats sending the command signal to the sensory array 320 whenever the control unit 410 receives the activating control signal from the processor 220 of FIG. 2. Upon receiving the command signal, the sensory array 420 repeats the same process of controlling the light sensors 430 in order to detect light, to measure the amount of photon energy of the detected light, to convert the amount of photon energy into the electric signal, and to transmit the electric signal to the control unit 410.

When the control unit 410 receives the deactivating control signal from the processor 220 of FIG. 2, the control unit 410 sends a stop signal to the sensory array 320 in order to terminate detecting light. The sensory array 420 then deactivates the light sensors 330 to terminate detecting light. The sensory array 420 then switches into a waiting mode.

In another embodiment, the light sensors 430 of the sensory array 420 are not in a linear array form. Any feasible form of the light sensors 330 may be employed in the sensory array 420.

In another embodiment, the sensory array 420 uses a binary code. In this embodiment, when the photocurrent energy generated by the light sensors 430 exceeds a certain threshold, the sensory array 420 converts the photocurrent energy into ‘1’ meaning that light has been detected. When the current does not exceed the threshold, the sensory array 420 converts the photocurrent energy into ‘0’ meaning that no light has been detected.

In another embodiment, the threshold of voltage output is determined by the user. The user may set up a threshold of photocurrent energy. In this embodiment, when the user sets up 5V as the threshold, any photocurrent energy that does not exceed 5V will be determined as “no light,” which means that particles between the photon generator 150 and photon sensor 170 are highly dense thus blocking light.

In another embodiment, the user sets up a number of thresholds of photocurrent energy. For example, if the user sets up four levels of thresholds for the photocurrent energy level, 2V, 4V, 6V, and 8V, then any photocurrent energy level under 2V will be determined as “complete sediment,” any photocurrent energy level above 2V but under 4V will be determined as “high dense sediment,” any photocurrent energy level above 4V but under 6V will be determined as “medium dense sediment,” any photocurrent energy level above 6V but under 8V will be determined as “low sediment,” and any photocurrent energy level above 8V will be determined as “no sediment.”

In another embodiment, the photon sensor 170 includes two CPLDs. Each CPLD is electrically connected with the sensory array 420 and controls the sensory array 320.

FIG. 5 illustrates a block diagram of the data packet representing the amount of photon energy measured by the photon sensor 170 of FIG. 4.

The data packet 500 includes a first sensory data 510 and a second sensory data 520. The first sensory data 510 includes a first data bit 530 and a second data bit 540.

The first sensory data 510 represents the amount of photon energy measured by the first light sensor 440 of the sensory array 420 of FIG. 4. The second sensory data 520 represents the amount of photon energy measured by the second light sensor 450 of the sensory array 420 of FIG. 4.

In operation, when the light sensors 430 of FIG. 4 detect light, the sensory array 420 converts the amount of photon energy measured by the light sensors 430 into an electric signal. The sensory array 430 then transmits the electronic signal to the control unit 410. The control unit 410 then converts the electric signal into the data packet. For the preferred embodiment, the control unit 410 receives the electric signal in a form of a binary decimal. The control unit 410 places the binary decimal representing the amount of photon energy measured by the first light sensor 440 of the sensory array 420 in the first sensory data 510. Preferably, each sensory data is composed of an 8-bit data packet.

Next, the control unit 310 puts the binary decimal representing the amount of photon energy measured by the second light sensor 450 of the sensory array 420 in the second sensory data 530. In the preferred embodiment, the number of sensory data is equal to the number of total light sensors 430 installed in the sensory array 420. For example, if the sensory array 420 includes 128 light sensors then the data packet 500 includes 128 sensory data. If the first light sensor 440 of the sensory array 420 measured 3V of photocurrent energy then the control unit 410 will put the binary decimal of ‘11’ in the first sensory data 510.

In another embodiment, the sensory array 420 converts the measured amount of photon energy into a binary code, either ‘0’ or ‘1’ (‘0’ representing no light and ‘1’ representing the most saturated light). In this embodiment, each data bit in the data packet 500 represents the amount of photon energy measured by each light sensor of FIG. 4. For example, when the first light sensor 440 detects light, the control unit 410 puts ‘1’ in the first data bit 530. When the second light sensor 450 does not detect light, the control unit 410 puts ‘0’ in the second data bit 540.

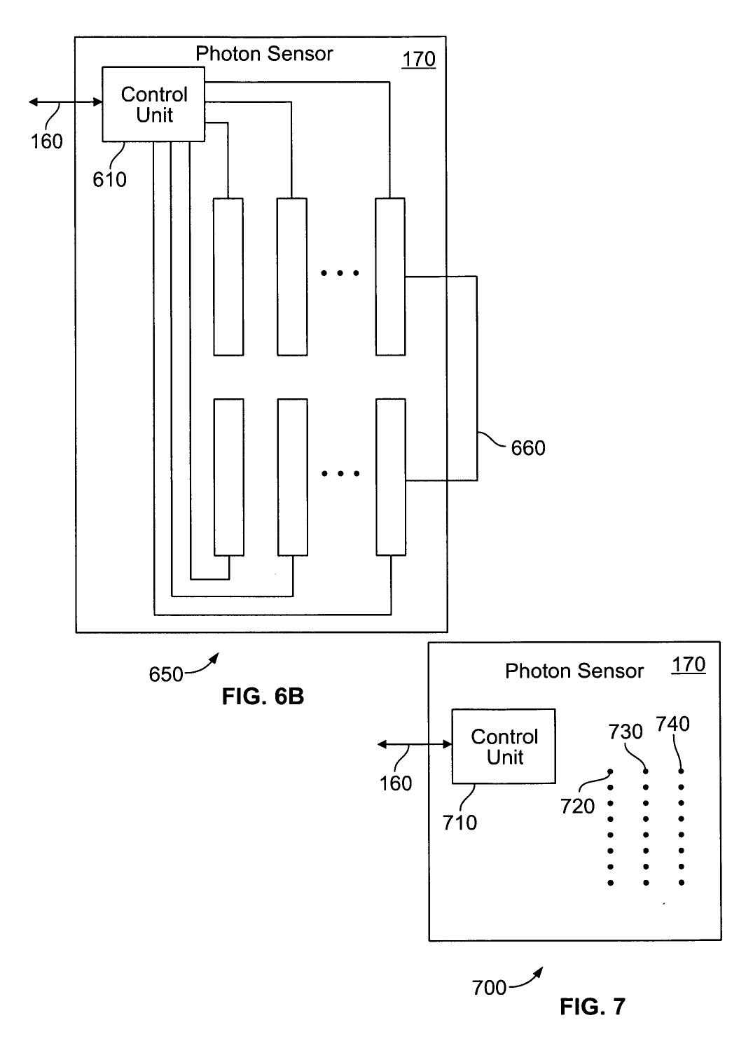

FIG. 6A illustrates a block diagram of a first alternative embodiment of the photon sensor 170 of FIG. 4.

The first alternative embodiment of the photon sensor 600 includes a control unit 610, a first sensory array 620, first sensory array light sensors 625, a second sensory array 630, second sensory array light sensors 635, a third sensory array 640, and third sensory array light sensors 645.

The control unit 610 is electrically connected with the first sensory array 620. The control unit 610 is electrically connected with the second sensory array 630. The control unit 610 is electrically connected with the third sensory array 640. The first sensory array 620 is electrically connected with the first sensory array light sensors 625. The second sensory array 630 is electrically connected with the second sensory array light sensors 635. The third sensory array 640 is electrically connected with the third sensory array light sensors 645.

In operation, the first alternative embodiment of the photon sensor 600 functions in the same manner as the photon sensor 170 of FIG. 4 except that the control unit 610 now controls three sensory arrays instead of one. Preferably, each sensory array controls 128 light sensors respectively. Upon receiving the activating control signal from the processor 220 of FIG. 2, the control unit 610 sends a command signal to the first sensory array 620, the second sensory array 630, and the third sensory array 640 respectively. Preferably, the control unit 610 sends the command signal to the first sensory array 620, the second sensory array 630, and the third sensory array 640 simultaneously. The first sensory array 620 controls the first sensory array light sensors 625 to detect light and to measure the amount of photon energy of the detected light. The second sensory array 630 controls the second sensory array light sensors 635 to detect light and to measure the amount of photon energy of the detected light. The third sensory array 640 controls the third sensory array light sensors 645 to detect light and to measure the amount of photon energy of the detected light. Preferably, the first sensory array 620, the second sensory array 630, and the third sensory array 640 commands the first sensory array light sensors 625, the second sensory array light sensors 635, and the third sensory array light sensors 645 to detect light simultaneously. After measuring the amount of photon energy, the first sensory array 620 converts the measured amount of photon energy into an electric signal and then transmits the electric signal to the control unit 610. The second sensory array 630 converts the measured amount of photon energy into an electric signal and then transmits the electric signal to the control unit 610. The third sensory array 640 converts the measured amount of photon energy into an electric signal and then transmits the electric signal to the control unit 610.

Upon receiving the electric signal, the control unit 610 generates the data packet 500 of FIG. 5. The number of data packets generated by the control unit 610 equals to the number of sensory arrays installed in the photon sensor 170. For example, the first data packet represents the amount of photon energy measured by the first sensory array 620. The second data packet represents the amount of photon energy measured by the second sensory array 630. The third data packet represents the amount of photon energy measured by the third sensory array 640. Preferably, the first data packet is composed of 128 8-bit memory slots. Each memory slot represents the amount of photon energy measured by each light sensor of the sensory array. Once the control unit 610 completes generating all three data packets, the control unit 610 transmits all three data packets to the main controller 130 of FIG. 1. Preferably, three data packets represent 3*128 different measurement points.

FIG. 6B illustrates a block diagram of a second alternative embodiment of the photon sensor 170 of FIG. 4.

Like FIG. 6A, the second alternative embodiment of the photon sensor 650 includes the control unit 610. Unlike the first alternative embodiment of the photon sensor 600 of FIG. 6A, the second alternative embodiment 650 includes more than three sensory arrays 660. Each sensory array is electrically connected with the control unit 610.

In operation, the second alternative embodiment of the photon sensory 650 collects the data representing the amount of photon energy measured by multiple sensory arrays in the same manner as the first alternative embodiment of the photon sensor 600 of FIG. 6A. Preferably, the number of sensory arrays may increase up to 64. The control unit 610 generates the data packet 500 for each sensory array in the same manner as described above in FIG. 6A. Preferably, the control unit 610 generates total number of 64 data packets. For example, the first data packet represents 128 different measurement points measured by the first sensory array.

FIG. 7 illustrates a block diagram of a third alternative embodiment of the photon sensor 170 of FIG. 4.

The third alternative embodiment of the photon sensor 700 includes a control unit 710, a first light sensor 720, a second light sensor 730, and a third light sensor 740.

The first light sensor 720 is electrically connected with the control unit 710. The second light sensor 730 is electrically connected with the control unit 710. The third light sensor 740 is electrically connected with the control unit 710.

In operation, unlike the photon sensor 170 of FIG. 1, the control unit 710 directly controls discrete light sensors. Preferably, a center-to-center spacing between each light sensor is less than 1.26 mm. In one embodiment, the discrete light sensors are photodiodes. The control unit 710 controls the first light sensor 720 to detect light and to measure the amount of photon energy of the detected light. The control unit 710 controls the second light sensor 730 to detect light and to measure the amount of photon energy of the detected light. The control unit 710 controls the third light sensor 740 to detect light and to measure the amount of photon energy of the detected light. Preferably, the control unit 710 may control up to 128 discrete light sensors. Preferably, the first light sensor 720, the second light sensor 730, and the third light sensor 740 detects light and measure the photon energy of the detected light simultaneously.

After measuring the photon energy, the first light sensor 720 generates photocurrent energy representing the amount of photon energy measured by the first light sensor 720. The second light sensor 730 generates photocurrent energy representing the amount of photon energy of the light detected by the second light sensor 730. The third light sensor 740 generates photocurrent energy representing the amount of photon energy of the light detected by the third light sensor 740. The photocurrent energy is transmitted to the control unit 710. The control unit 710 then converts the photocurrent energy into the data packet 500 of FIG. 5.

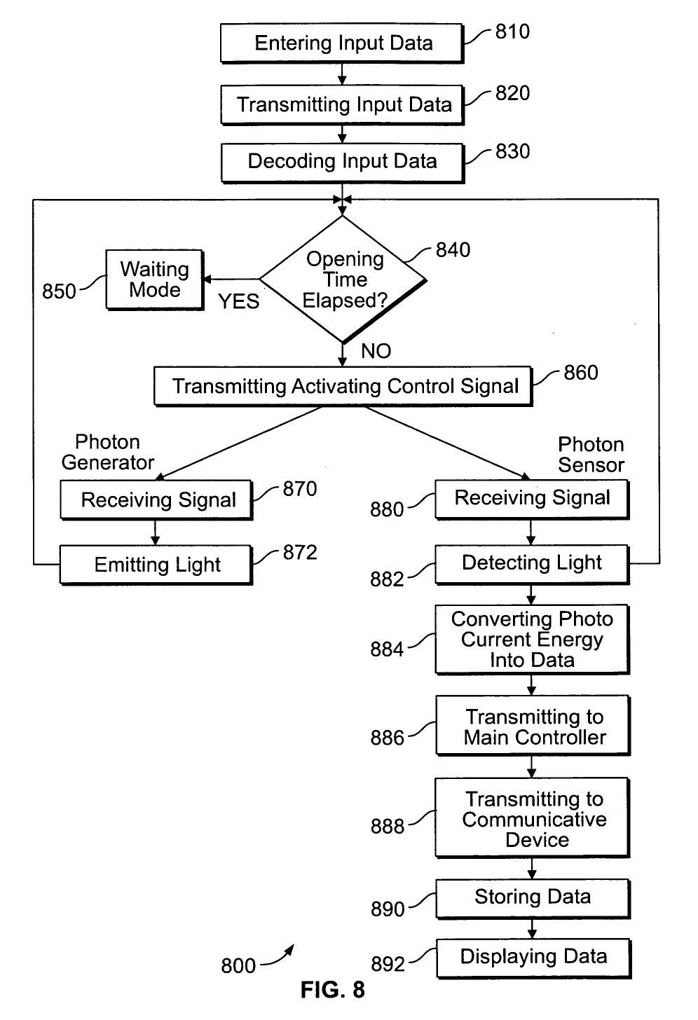

FIG. 8 illustrates a flowchart of a method for measuring particle concentration 800.

First, at step 810, a user enters in an input data using the communicative device 110 of FIG. 1. The input data includes a sampling rate, the duration of an operating time, and light settings. The light settings include a particular type of light and intensity level of light.

Next, at step 820, the communicative device 110 transmits the input data to the main controller 130 of FIG. 1.

Next, at step 830, the main controller 130 decodes the input data and determines the sampling rate and the duration of the operating time defined by the user. The main controller 130 also determines the type of light and the intensity level of light defined by the user. Based on the determined sampling rate, the main controller 130 sets up a clock cycle. The main controller 130 then initiates running the clock cycle. Preferably, the main controller 130 embodies a crystal oscillator with 60 Mhz clock pulse in order to keep timing.

Next, at step 840, the main controller 130 checks the running time in order to figure out whether the duration of the operating time has elapsed. If the duration of the operating time has elapsed, the main controller 130, at step 850, goes to a waiting mode. In the waiting mode, the main controller 130 waits for the next input data. If the duration of the operating time has not elapsed yet, the main controller 130, at step 860, transmits the activating control signal to the photon generator 150 and the photon sensor 170. Preferably, the main controller 130 transmits the activating control signal to the photon generator 150 and the photon sensor 170 simultaneously.

Next, at step 870, the photon generator 150 receives the activating control signal from the main controller 130.

Next, at step 872, the photon generator 150 emits the type of light as determined by the main controller 130 at the level of intensity determined by the main controller 130 at step 830.

Next, at step 880, the photon sensor 170 receives the activating control signal from the main controller 130. Preferably, step 870 and step 880 are performed simultaneously.

Next, at step 882, the photon sensor 170 starts to measure particle concentration. The photon sensor 170 detects light and then measure the amount of photon energy of the detected light. Preferably, the photon sensor 170 generates photocurrent energy in relation to the intensity of light detected by the photon sensor 170.

Next, at step 884, the photon sensor 170 converts the generated photocurrent energy into data. Preferably, the data represents the amount of photon energy measured by the photon sensor 170 at step 882.

Next, at step 886, the photon sensor 170 transmits the converted data to the main controller 130.

Next, at step 888, the main controller 130 transmits the data to the communicative device 110.

Next, at step 890, the communicative device 110 stores the data in a computer-readable medium.

Next, at step 892, the communicative device 110 displays the result to the user using the data. Preferably, the communicative device includes a LCD screen to display the result which represents particle concentration of a medium between the photon generator 150 and the photon sensor 170.

Preferably, after step 872 and step 882, the main controller 130 re-checks the running time at step 840. If the duration of the operating time has not elapsed yet, the main controller repeats transmitting the activating control signal to the photon generator 150 and the photon sensor 170 respectively as described above at step 860. If the duration of the operating time has elapsed, the main controller 130, at step 850, goes into a waiting mode.

FIG. 9 illustrates a user interface of control settings for the system for measuring particle concentration of FIG. 1 in accordance with an embodiment of the present invention. The user interface of control settings 900 includes a “Sampling Parameter” section 910, a “Light Settings” section 920, a “Start Settings” section 930, a “Start” menu 940, a “Stop” menu 950, a “Display Result” menu 960, a “Display Real Time” menu 970. The “Sampling Parameter” section 910 includes a “Rate (Hz)” menu 912 and a “Duration (sec)” menu 914. The “Light Settings” section 920 includes an “Intensity” menu 922 and a “Type” menu 924. The “Type” menu 924 includes an “Infrared” menu 925, a “Ultraviolet” menu 926, and a “Visible Light” menu 927. The “Start Settings” section 930 includes an “Automatic” menu 932, a “Start on Trigger” menu 934, and a “Manual” menu 936.

The “Sampling Parameter” section 910 provides a user interface for setting up a sampling rate and the duration of an operating time for the system. The “Light Settings” section 920 provides a user interface for setting up the intensity level and the type of light. The “Start Settings” section 930 provides a user interface for setting up the start conditions to trigger the system to measure particle concentration. The “Start” menu 940, the “Stop” menu 950, the “Display Result” menu 960, and the “Display Real Time” menu 970 are the controlling options for the user.

In operation, the user may enter any sampling rate at which the system measures particle concentration into the “Rate (Hz)” menu 912. Preferably, the communicative device 110 of FIG. 1 provides the user interface of control settings 900. In the preferred embodiment, the user may enter the sampling rate into a blank space next to the “Rate (Hz)” menu. Preferably, the sampling rate is measured in Hz. For example, if the user enters ‘500’ into the “Rate (Hz)” menu 912, the system 100 measures particle concentration for 500 times in every second. The user also may enter any preferred time period during which the system 100 measures particle concentration into the “Duration (sec)” menu 914. Preferably, duration is measured in second. For example, if the user enters ‘30’ into the “Duration (sec)” menu 914, the system 100 measures particle concentration for 30 seconds.

With regard to the “Light Settings” section 920, the user may choose a particular level of intensity at which the photon generator 150 emits light by selecting such level of intensity in the “Intensity” menu 922. Preferably, the user interface for the “Intensity” menu 922 is a bar-type button. The button is scaled from 10% to 100%, a left-end being 10% and a right-end being 100%. If the user selects any space between the left-end and the right-end, the appropriate level of intensity will be selected in proportion to the distance between the left side of the button and the position selected by the user. For example, if the user selects the middle position of the button, 50% intensity will be selected.

The user also may select the type of light by choosing one of options in the “Type” menu 924. Preferably, the “Type” menu 924 is composed of three sub-menus: the “Infrared” menu 925, the “Ultraviolet” menu 926, and the “Visible Light” menu 927. The preferred embodiment provides a blank space below each menu. The user may enter desired percentage of light type that will be emitted by the photon generator 150 of FIG. 1 in each blank space. Preferably, the sum of each percentage should be 100. For example, if the user enters ‘20’ in the “Infrared” menu 925 and ‘40’ in the “Ultraviolet” menu 926, the system automatically calculates the remaining 60% and displays the number ‘60’ in the blank space below the “Visible Light” menu 927.

The user may activate the system by clicking the “Start” menu 940. Once the user clicks the “Start” menu 940, the communicative device 110 of FIG. 1 transmits the input data to the main controller 130. Preferably, the input data represents a sampling rate, the duration of an operation time, and light settings. The main controller 130 transmits the activating control signal to the photon generator 150 and the photon sensor 170 as described above in FIG. 2. When the user clicks the “Stop” menu 940, the main controller transmits the deactivating control signal to the photon generator 150 and the photon sensor 170 as described above in FIG. 2.

With regard to the “Start Settings” section 930, the user may choose a certain way to trigger the system to measure particle concentration. First option is an automatic triggering. If the user selects the “Automatic” menu 932 and then click “Start” menu 940, the system 100 measures particle concentration at the sampling rate defined by the user for the duration of the operating time defined by the user. Second option requires to use the external device 180 of FIG. 1, which is electrically connected with the main controller 130 of FIG. 1. If the user selects the “Start on Trigger” menu 934 and then clicks the “Start” menu 940, the system switches its status to an “armed” mode. In the “armed” mode, the system starts to measure particle concentration only when the main controller 130 receives a triggering signal from the external device. Upon receiving the triggering signal from the external device, the system 100 measures particle concentration at the sampling rate defined by the user for the duration of the operating time defined by the user. Final option is a manual mode. In this manual mode, the main controller is also electrically connected with the external device 180 of FIG. 1. When the user selects the “Manual” menu 936 and then clicks the “Start” menu 940, the system measures particle concentration only when it receives a triggering signal from the external device. The sampling rate and the duration of the operating time defined by the user are not operable in the “Manual” menu 936. Only the triggering signal generated by the external device 180 triggers the system to measure particle concentration.

When the user clicks the “Display Result” menu 960, a new screen pops up and displays the measured particle concentration of a medium between the photon generator 150 and the photon sensor 170 (as shown below in FIG. 10).

When the user clicks the “Display Real Time” menu 970, a new screen pops up and displays the real-time result of particle concentration (as shown below in FIG. 11).

In another embodiment, any different graphics, designs, texts, or symbols may be used to construct the menus or the layouts of the user interface of control settings 900.

FIG. 10 illustrates a plan view of a first particle concentration display 1000. The first particle concentration display 100 includes a horizontal display axis 1010, a vertical display axis 1020, and first particle concentration data 1030.

In the first particle concentration display 1000, the horizontal axis 1010 is affixed to the vertical axis 1020. The horizontal axis 1010 is perpendicular to the vertical axis 1020. The first particle concentration data 1030 is disposed between the horizontal axis 1010 and the vertical axis 1020.

In operation, the first particle concentration display 1000 illustrates particle concentration of a medium between the photon generator 150 and the photon sensor 170 during a certain period of time. The horizontal axis 1010 represents a time frame. Preferably, the horizontal axis 1010 represents second. The vertical axis 1020 represents the amount of photon energy measured by the light sensors 430 of FIG. 4. Preferably, the vertical axis 1020 represents the amount of photon energy measured by 128 light sensors. Preferably, the first particle concentration display 1000 displays a coloered dot as a measurement point where a light sensor detected the amount of photon energy that exceeds a certain threshold set by the user. For example, if the user set 3V as the threshold, any voltage output generated by a light sensor exceeding 3V will be displayed as a colored dot. Any voltage output generated by a light sensor not exceeding 3V will be displayed as a blank dot. The first particle concentration data 1030 indicates that a group of dense particles was detected by light sensors between the time frame 2 and the time frame 5.

In another embodiment, the vertical axis 1020 represents a mean or average value of photocurrent energy measured by all light sensors installed in the sensory array 420 of FIG. 4. In this embodiment, more than one sensory array may be connected to the photon sensor 170. For example, a value ‘3’ of the vertical axis 1020 represents the mean value of photocurrent energy measured by all light sensors installed in a third sensory array.

In another embodiment, the vertical axis 1020 represents a mean or average value of photocurrent energy measured by all light sensors installed in the photon sensor 170. In this embodiment, more than one photon sensor 170 may be connected to the main controller 130 of FIG. 1. For example, a value ‘3’ of the vertical axis 1020 represents the mean value of photocurrent energy measured by all light sensors installed in a third photon sensor.

FIG. 11 illustrates a perspective view of a second particle concentration display 1100. The second particle concentration display 1100 includes a X-axis 1110, a Y-axis 1120, a Z-axis 1130, and second particle concentration data 1140.

In the second particle concentration display 1100, the X-axis 1110 is affixed to the Y-axis 1120. The Y-axis 1120 is affixed to the Z-axis 1130. The X-axis 1120 is perpendicular to the Y-axis 1120. The Y-axis 1120 is perpendicular to the Z-axis 1130. The second particle concentration data 1140 is disposed between the X-axis 1110 and the Y-axis 1120.

In operation, the second particle concentration display 1100 illustrates particle concentration of a medium between the photon generator 150 and the photon sensor 170 during a certain period of time in a 3D image. The X-axis 1110 represents a time frame. Preferably, the X-axis 1110 represents second. The Y-axis 1120 represents the amount of photon energy measured by the light sensors 430 of FIG. 4. Preferably, the Y-axis 1120 represents the amount of photon energy measured by 128 light sensors. The Z-axis 1130 represents a degree of particle concentration. Preferably, the Z-axis 1130 ranges from 0 to 10. Preferably, the higher number the Z-axis indicates, more concentrated particles are.

In another embodiment, the Z-axis represents the number of the sensory array 420 of FIG. 4. Preferably, the Z-axis ranges from 1 to 64. For example, ‘1’ in the Z-axis represents the mean value of photon energy measured by all light sensors installed in the first sensory array of the photon sensor 170 and ‘64’ in the Z-axis represents the mean value of photon energy measured by all light sensors installed in the sixty-fourth sensory array of the photon sensor 170.

In another embodiment, the Z-axis represents the number of the photon sensor 170 of FIG. 1. Preferably, the Z-axis ranges from 1 to 32. For example, ‘1’ in the Z-axis represents the mean value of photon energy measured by all light sensors of the first photon sensor and ‘32’ in the Z-axis represents the mean value of photon energy measured by all light sensors of the thirty-second photon sensor.

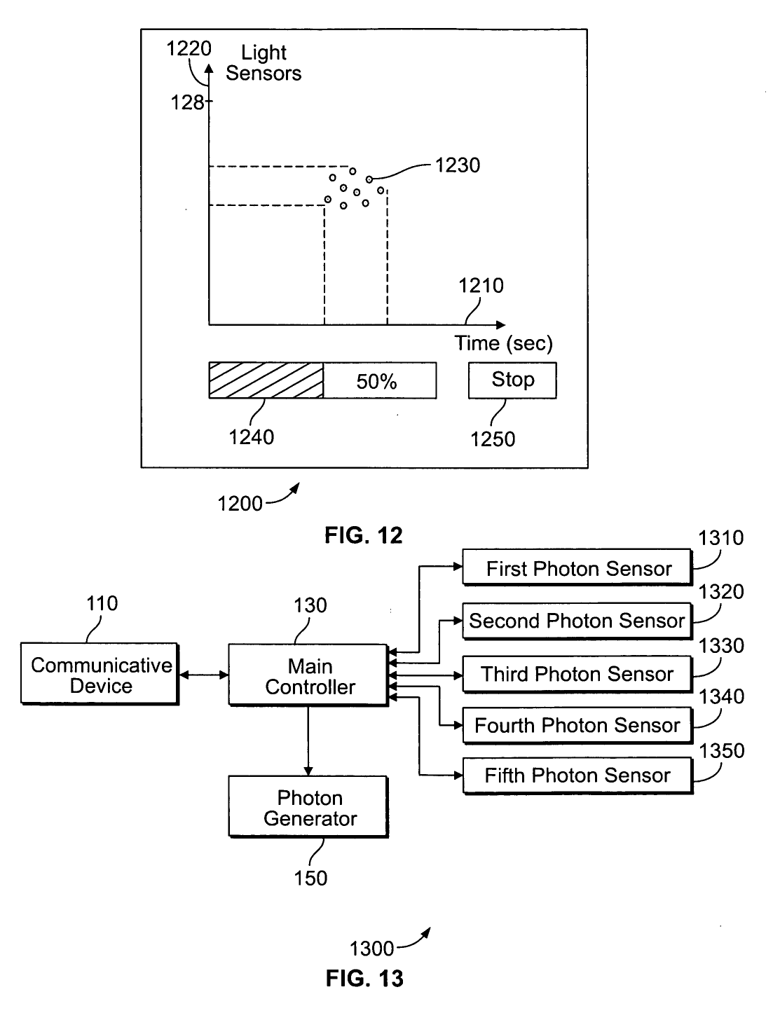

FIG. 12 illustrates a plan view of a real-time display of particle concentration 1200. The real-time display of particle concentration 1200 includes a horizontal axis 1210, a vertical axis 1220, third particle concentration data 1230, a progress bar 1240, and a “Stop” menu 1250.

In the real-time display of particle concentration 1200, the horizontal axis 1210 is affixed to the vertical axis 1220. The horizontal axis 1210 is perpendicular to the vertical axis 1220. The third particle concentration data 1230 is disposed between the horizontal axis 1210 and the vertical axis 1220.

In operation, when the user checks the “Display Real Time” menu 970 and then presses the “Start” menu 940 of FIG. 9, the real-time display of particle concentration 1200 pops up with a new window screen. The real-time display of particle concentration 1200 displays changes in particle concentration of a medium between the photon generator 150 and the photon sensor 170 in a real time. Like the first particle concentration display 1000 of FIG. 10, the horizontal axis 1210 represents a time frame. Preferably, the horizontal axis 1210 represents second. The vertical axis 1220 represents the amount of photon energy measured by the light sensors 430 of FIG. 4. Preferably, the vertical axis 1220 represents the amount of photon energy measured by 128 light sensors. Like the first particle concentration data 1030 of FIG. 10, the third particle concentration data 1230 is composed of colored dots and blank dots. The colored dots represent measurement points where particles are dense. The blank dots represent measurement points where particles are scarce.

The progress bar 1240 indicates the progress of measuring particle concentration. Preferably, the progress bar 1240 is a typical progress bar indicating a percentage of the elapsed time in relation to the total operating time. For example, if the operating time was set as 100 seconds by the user and the 50 seconds are elapsed from the time the user pressed the “Start” menu 940 of FIG. 9, the progress bar 1240 will indicate ‘50%’ in the bar. Finally, when the user presses the “Stop” menu 1250, the communicative device 110 closes the window that displays the real-time display of particle concentration 1200.

In another embodiment, any different graphics, designs, texts, or symbols may be used to construct the menus or the layouts of the screen showing the real-time display particle concentration 1200.

FIG. 13 illustrates an alternative embodiment of the system for measuring particle concentration 100 of FIG. 1. Like the system for measuring particle concentration 100 of FIG. 1, the alternative embodiment 1300 includes the communicative device 110, the main controller 130, and the photon generator 150. Unlike the system for measuring particle concentration 100, the alternative embodiment 1300 includes more than one photon sensor. The alternative embodiment 1300 includes a first photon sensor 1310, a second photon sensor 1320, a third photon sensor 1330, a fourth photon sensor 1340, and a fifth photon sensor 1350.

In the alternative embodiment 1300, the communicative device 110 is in bidirectional communication with the main controller 130 like the system for measuring particle concentration 100 of FIG. 1. The main controller 130 is in unidirectional communication with the photon generator 150. The main controller 130 is in bidirectional communication with the first photon sensor 1310. The main controller 130 is in bidirectional communication with the second photon sensor 1320. The main controller 130 is in bidirectional communication with the third photon sensor 1330. The main controller 130 is in bidirectional communication with the fourth photon sensor 1340. The main controller 130 is in bidirectional communication with the fifth photon sensor 1350.

In operation, the alternative embodiment 1300 functions in the same manner as the system for measuring particle concentration 100 of FIG. 1 except that the alternative embodiment 1300 collects more data from multiple photon sensors. By including more than one photon sensor 170, the alternative embodiment 1300 increases the number of measurement points than the system for measuring particle concentration 100 of FIG. 1, which uses only a single photon sensor 170. Like the photon sensor 170 of FIG. 1, the first photon sensor 1310, the second photon sensor 1320, the third photon sensor 1330, the fourth photon sensor 1340, and the fifth photon sensor 1350 measure the amount of photon energy of light detected by each photon sensor respectively. The number of photon sensors in the alternative embodiment 1300 may increase up to 32. In the preferred embodiment, the main controller 130 of FIG. 1 may communicate with as many as 32 photon sensors simultaneously. In one embodiment, each photon sensor includes the sensory array 420 of FIG. 4. In one embodiment, each photon sensor may include more than one sensory array. By including more than one sensory array, the alternative embodiment 1300 further increases the number of measurement points. In this embodiment, one photon sensor may include as many as 64 sensory arrays.

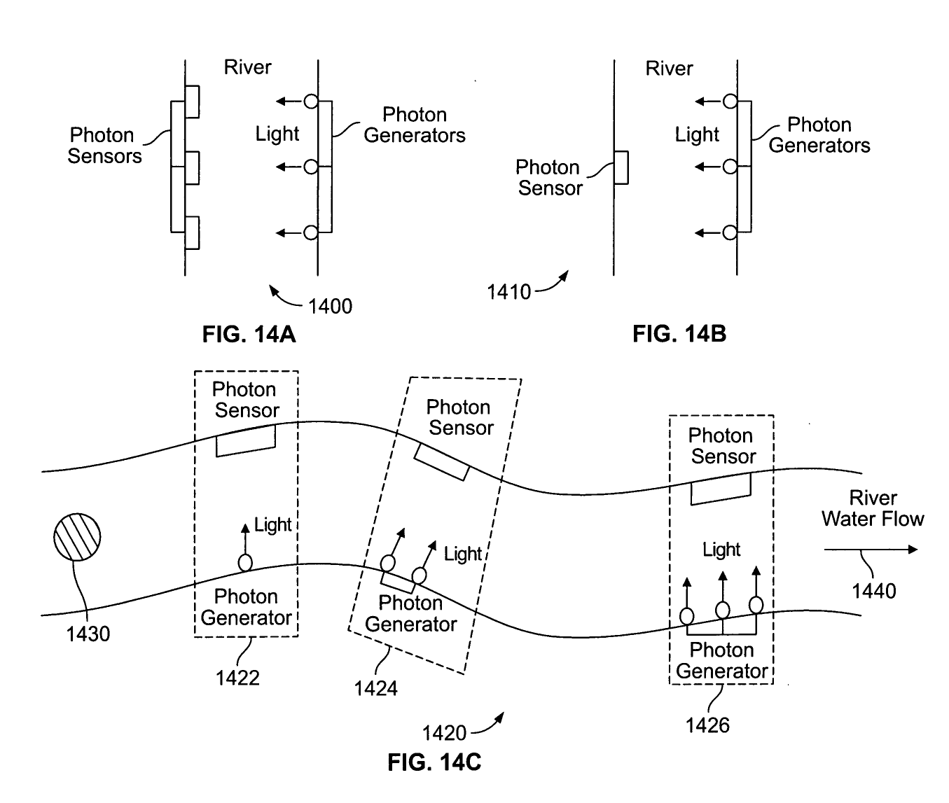

FIG. 14A illustrates a plan view of a first setting option for the alternative embodiment of the system for measuring particle concentration 1300 of FIG. 13.

The alternative embodiment of the system for measuring particle concentration 1300 provides flexible setting options for the user in measuring particle concentration. The user may locate multiple photon sensors along the riverside in different locations as shown in FIG. 14A. Each photon sensor detects light emitting by each photon generator 150. Preferably, one photon generator is paired with one photon sensor. Each photon generator emits light for the paired photon sensor.

FIG. 14B illustrates a plan view of a second setting option for the alternative embodiment of the system for measuring particle concentration 1300 of FIG. 13.

The second setting of the alternative embodiment of the system of measuring particle concentration 1410 shows another alternative way for setting the system. In this embodiment, the user places three photon generators 150 for one photon sensor 170. The user may increase or decrease the number of photon generators depending on the circumstances. When the user thinks more light is required in a particular location, the user may increase the number of photon generators in order to increase the intensity of light.

FIG. 14C illustrates a plan view of a third setting option for the alternative embodiment of the system for measuring particle concentration 1300 of FIG. 13.

The third setting of the alternative embodiment of the system for measuring particle concentration 1420 shows another alternative setting for the user. In this embodiment, the user sets up the system in three different locations: a first location 1422, a second location 1424, and a third location 1426. All three locations preferably represent a riverside area. The user may choose the number of photon sensors and the number photon generators to be located along the riverside depends on the light conditions or water flow 1440 conditions of surrounding environment. If water speed is faster in a particular location, the user may place more photon sensors and photon generators to provide more accurate measurement. In this embodiment, the user places a pair of photon generator and photon sensor at the first location 1422. The user places one photon sensor and two photon generators at the second location 1424. The user places one photon sensor and three photon generators at the third location 1426. A group of particles 1430 are travelling along the river. A water flow direction indicator 1440 shows the direction of water.

In operation, the alternative embodiment 1420 measures particle concentration at three different locations simultaneously. At the first location 1422, the system measures particle concentration of water flowing through the first location. At the second location 1424, the system measures particle concentration of water flowing through the second location. At the third location 1426, the system measures particle concentration of water flowing through the third location.

In another embodiment, the system measures a velocity of moving particles in water. When the group of particles 1430 in the river are moving in the same direction as that of the water flow direction indicator 1440 along the river and reaches the first location 1422, the photon sensor located at the first location 1422 first detects a sudden increase in particle concentration at the first location 1422 by sensing that less light is being detected. At this time, the photon sensor in the second location 1424 and the third location 1426 do not detect the same sudden change. As the group of particles 1430 move along the river and reaches the second location 1424, the photon sensor at the second location 1424 detects the sudden change in particle concentration because light emitting from the photon generator at the second location is blocked by the particles. At this time, there is no change in particle concentration at the third location 1426. As the group of particles 1430 move along the river and reaches the third location 1426, finally, the photon sensor at the third location 1426 detects the sudden change in particle concentration at the third location 1426 because light emitting from the photon generator at the third location 1426 is blocked by the particles 1430. By comparing a time interval between the first time the photon sensor at the first location 1422 detected the sudden change in particle concentration with the second time the photon sensor at the second location 1424 detected the sudden change in particle concentration, the system is able to estimate the velocity of the particles 1430.

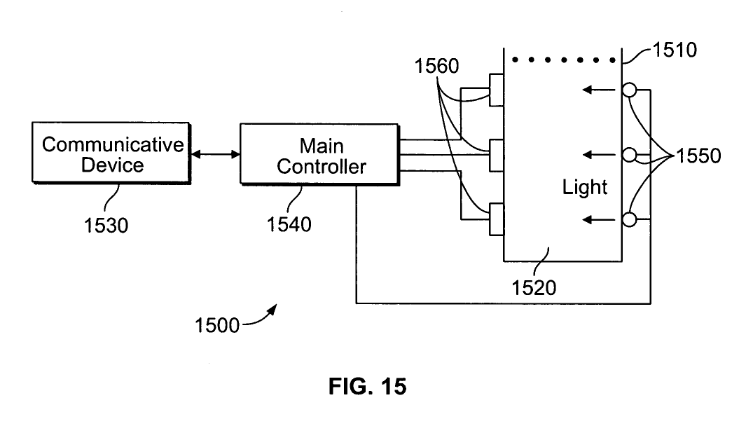

FIG. 15 illustrates an elevational view of the alternative embodiment of the system for measuring particle concentration 1300 of FIG. 13.

The elevational view of the alternative embodiment of the system for measuring particle concentration 1500 shows an example of measuring particle concentration in a lab environment.

The elevational view of the alternative embodiment of the system for measuring particle concentration 1500 includes a tank tube 1510, water in the tank tube 1520, the communicative device 1530, the main controller 1540, the photon generators 1550, and the photon sensors 1560.

The communicative device 1530 is in bidirectional communication with the main controller 1540. The main controller 1540 is in unidirectional communication with the photon generators 1550. The main controller 1540 is in bidirectional communication with the photon sensors 1560. The tank tube 1510 is occupied with water 1520.

In operation, the photon sensors 1560 are attached to the outside wall of the tank tube 1510. Preferably, the photon sensors 1560 are vertically aligned. The photon generators 1550 are attached to the opposite side of the tank tube 1510. Preferably, the photon generators 1550 are vertically aligned. The photon sensors 1560 detect light emitted by the photon generators 1550. By positioning the photon sensors 1560 and the photon generators 1550 at the opposite end of the tank tube 1510, the photon sensors 1560 are able to detect the changes in the intensity of light emitted by the photon generators 1550. By detecting the changes in the intensity of light, the system is able to detect the changes in particle concentration of water flowing between the photon generators 1550 and the photon sensors 1560.

In another embodiment, the user may increase or decrease the number of the photon generators 1550 and the photon sensors 1560.

In view of the forgoing teaching, embodiments of the present invention provide numerous advantages over other prior art systems known for measuring particle concentration.

The prior arts have a few disadvantages in terms of measuring particle concentration. First, the prior art systems contain certain limitations in generating and processing high volume of data, which constitutes a barrier in providing an effective measurement of particle concentration in real working environment. Some prior art systems are simply not designed to measure particle concentration with high spatial resolution or high temporal resolution. The system in Unger only uses a single pair of a light source and a detector generating only one measurement point data. Although the system in Schneider may use more than one measuring head, this does not actually increase the spatial resolution because the size of the area which can be detected by each measuring head is fixed regardless of the number of measuring heads being used. Another prior art, SediMeter, provides up to 0.1 mm spatial resolution by using 36 detectors. This spatial resolution, however, limits SediMeter in providing accurate measurement of particle concentration in real working environment because particles size less than 0.1 mm are not detectable by SediMeter. SediMeter is also limited to add only up to 36 detectors due to its physical body size. Moreover, SediMeter's temporal resolution, 5 Hz, makes SediMeter impossible to detect any change in concentration that occurs within 5 seconds.

The system in Bright uses the array-based photon detectors to increase the spatial resolution, however, is limited in increasing the absolute number of measurement points because it measures particle concentration of analytes placed only on the luminophores. The size of the measurement area is inherently limited to the size of the area covered by the luminophores, which limits the ability of the system to expand the measuring area. In addition, the analytes need to be replaced manually for each measurement, which in turn, limits the system's temporal resolution. Due to these limitations, the system in Bright is not workable in working environment where the system needs to measure particle concentration constantly on a large scale.

Unlike the prior art systems, the system for measuring particle concentration 100 of FIG. 1 measures and collects a large volume of data while maintaining high spatial and temporal resolution. By using the processor 220 of the main controller 130, the system for measuring particle concentration 100 effectively communicates with the control unit 410 of the photon sensor 170. Even though the sensory array 420 of FIG. 4 generates a large volume of data during each clock cycle, measuring up to 400 measurement points per inch, the system 100 is still manageable to further increase the number of measurement points by either increasing the number of photon sensors 170 or the number of sensory arrays 420. By adding more sensory arrays (up to 64) to a single photon sensor 170 of FIG. 1, the system is able to expand the scope of measuring area while maintaining the same high spatial resolution. Also, the system may control up to 32 photon sensors 170 of FIG. 1, which also increases the number of measurement points. Lastly, the system for measuring particle concentration 100 maintains a high temporal resolution (max 1,000 Hz) while collecting such large volume of data. The ability to collect high volume of data while maintaining high spatial and temporal resolution provides more accurate measurement of particle concentration in real working environment.

Other prior art systems do not provide such functionality to handle a large volume of data because they are limited in either increasing the number of measurement points or increasing the spatial resolution or temporal resolution. For example, SediMeter has only 0.01 mm of spatial resolution with 5 Hz temporal resolution. The system in Schneider has a structural limitation in increasing the density of measurement points. The system in Bright is limited in increasing the number of measurement points. Moreover, none of the prior art systems maintain as high a temporal resolution as that of the system for measuring particle concentration 100.

Second, the prior art systems fail to provide flexible setting options for a user. The prior art systems are not designed to fit for constantly changing surrounding environments. The system in Unger provides only a single measurement point with a single pair of a laser beam and a photodiode. The user cannot measure multiple points simultaneously with the Unger's system. Even though the system in Schneider provides a method of measuring multiple points simultaneously by using multiple measuring heads, the system is still restricted to the structure of the measuring head. The system does not allow the user to add more light sources or increase the intensity of light in a particular location where brighter light condition is required.

The system in Bright provides a method of changing wavelengths of light by changing the type of scintillation material. However, it is still restricted in the sense that each scintillation material must be matched with a particular luminophore. This matching pair of scintillation material and luminophore can only detect a particular type of analyte. These limitations significantly limit the working environment of the system in Bright.

Unlike the prior art systems, the system for measuring particle concentration 100 of FIG. 1 provides flexible setting options to a user providing a high degree of adaptability to various surrounding environments. Unlike the systems in Schneider and Unger which do not allow a user to change light settings, the system for measuring particle concentration 100 allows the user to vary the type and the intensity level of light easily by changing the menus in the “Light Settings” section 920. Unlike the system in Bright in which a user needs to change the whole matching pair of luminophore and scintillator in order to change wavelength of light, the flexible setting options in the system 100 provides an efficient and convenient way to adjust to different light conditions. By modulating the photon generator 150 of FIG. 1, the system gives significant benefit under conditions in which a constant light source would be hard to detect. The photon sensor 170 of FIG. 1 would be able to detect the regular variation in light intensity and use that as a filter to discern the generated signal from any ambient light, thus greatly extending the working environment of the photon sensor 170.

In addition, the system for measuring particle concentration 100 of FIG. 1 allows the user to increase or decrease the number of photon generators 150 or photon sensors 170 of FIG. 1. For example, the user can easily add more photon generators in a location where higher intensity of light is required by connecting more photon generators to the main controller 130. Unlike the systems in Schneider and Unger, in which light source element and light detector element are physically paired with each other, the system for measuring particle concentration 100 separated the photon generator 150 from the photon sensor 170 in order to expand the adaptability of the system to different working environments.

Third, the prior art systems provide limited applications. The system in Unger measures only air particle concentration. SediMeter measures only liquid particle concentration. The system in Bright only measures concentration of analytes. The system in Bright is not designed to measure particle concentration in liquid or air. The system in Schneider may be used to measure dye concentration both in submarine and atmospheric conditions; however, the system is limited to measuring particle concentration of a small region due to its structural limitation.

Unlike the prior art systems, the present invention provides multiple practical applications to the user. The present invention may be used to measure particle concentration in liquid or gaseous medium. The present invention may also be used to differentiate complex regions of various materials. By using various light wavelengths, the system is able to measure the light intensity differences and discern the interfaces or various fluids because even clear water will have an effect of the attenuation of light. Finally, the present invention may be used to calculate the velocity of particles or objects travelling through water by appropriately deploying multiple photon sensors and photon generators in different locations as described in FIG. 14C.

The above advantages of the system for measuring particle concentration 100 of FIG. 1 combined together provide more efficiency and convenience to the users in measuring particle concentration in liquid or gaseous medium in various working conditions. Not only the system is more convenient and efficient to measure particle concentration but also the system provides a more accurate result of particle concentration compare to the prior art systems. Other benefits of the present invention will be recognized by one of ordinary skill in the art.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

What is claimed is:

1. A method for measuring particle concentration said method including:
emitting light from a photon generator wherein said photon generator is composed of a light emitting diode wherein said light emitting diode emits light;
detecting said light using a photon sensor wherein a main controller controls said photon sensor to detect said light wherein said main controller is in communication with said photon sensor wherein said photon sensor is composed of at least one sensory array wherein said sensory array is composed of a plurality of light sensors wherein said plurality of light sensors measure photon energy of said light wherein said main controller controls said photon sensor to perform said detecting in a periodic basis;
transmitting data wherein said photon sensor transmits said data to said main controller wherein said data represents the amount of photon energy measured by said plurality of light sensors;
receiving said data wherein said main controller receives said data from said photon sensor;
transmitting said data wherein said main controller transmits said data to a communicative device wherein said main controller is in communication with said communicative device;
receiving said data wherein said communicative device receives said data from said main controller; and
determining particle concentration based on said data wherein said communicative device determines said particle concentration wherein said particle concentration is determined in proportion to said amount of photon energy represented by said data.

2. The method of claim 1 wherein a center-to-center spacing between said plurality of light sensors is less than about 1.26 mm.

3. The method of claim 1 wherein said periodic basis ranges from 0.001 to 1 second.

4. The method of claim 1 wherein said plurality of light sensors are arranged in a linear array form.

5. The method of claim 1 wherein said main controller controls a plurality of said photon sensors to detect said light wherein said main controller is in communication with each of said plurality of photon sensors wherein said main controller controls said plurality of photon sensors to perform said detecting in said periodic basis.

6. The method of claim 1 wherein said photon generator and said photon sensor are attached to a circuit board.

7. A system for measuring particle concentration said system including:
a photon generator emitting light wherein said photon generator is composed of a light emitting diode wherein said light emitting diode emits light;
a photon sensor detecting said light wherein said photon sensor is composed of at least one sensory array wherein said sensory array is composed of a plurality of light sensors wherein said plurality of light sensors measure photon energy of said light,
transmitting data wherein said photon sensor transmits said data to a main controller wherein said data represents the amount of photon energy measured by said plurality of light sensors;
said main controller controlling said photon sensor wherein said main controller controls said photon sensor to detect said light wherein said main controller is in communication with said photon sensor wherein said main controller controls said photon sensor to perform said detecting in a periodic basis,
receiving said data wherein said main controller receives said data from said photon sensor,
transmitting said data wherein said main controller transmits said data to a communicative device wherein said main controller is in communication with said communicative device; and
said communicative device receiving said data wherein said communicative device receives said data from said main controller,
determining particle concentration based on said data wherein said communicative device determines said particle concentration wherein said particle concentration is determined in proportion to said amount of photon energy represented by said data.

8. The system of claim 7 wherein a center-to-center spacing between said plurality of light sensors is less than about 1.26 mm.

9. The system of claim 7 wherein said periodic basis ranges from 0.001 to 1 second.

10. The system of claim 7 wherein said plurality of light sensors are arranged in a linear array form.

11. The system of claim 7 wherein said main controller controls a plurality of said photon sensors to detect said light wherein said main controller is in communication with each of said plurality of photon sensors wherein said main controller controls said plurality of photon sensors to perform said detecting in said periodic basis.

12. The system of claim 7 wherein said photon generator and said photon sensor are attached to a circuit board.

13. A system for emitting light for measurement said system including:
a photon generator emitting light wherein said photon generator is composed of at least one light emitting diode wherein said light emitting diode emits a particular type of electromagnetic radiation; and
a main controller selecting at least one light emitting diode,
controlling said photon generator to emit light wherein said main controller controls said photon generator to activate selected light emitting diode to emit light wherein said main controller is in communication with said photon generator; and
a photon sensor detecting said light wherein said photon sensor detects said light emitted from said photon generator.

14. The system of claim 13 wherein said main controller determining a particular intensity level of said emitting light,
controlling said photon generator to emit light wherein said main controller controls said photon generator to activate said selected light emitting diode to emit light at said particular intensity level.

15. The system of claim 13 wherein said particular type of electromagnetic radiation includes one of infrared, visible light, and ultraviolet.

16. The system of claim 14 wherein said particular intensity level of light is determined by using a pulse width modulation method.

17. The system of claim 14 further including:
a communicative device receiving an input data from a user wherein said input data represents a particular type of electromagnetic radiation and a particular intensity level of light,
transmitting said input data to said main controller wherein said communicative device is in communication with said control unit; and
said main controller receiving said input data from said communicative device,
decoding said input data wherein said main controller determines said particular type of electromagnetic radiation represented by said input data as a determined type of electromagnetic radiation wherein said main controller determines said particular intensity level of light represented by said input data as a determined intensity level,
selecting a light emitting diode which emits said determined type of electromagnetic radiation,
controlling said photon generator wherein said photon generator activates said selected light emitting diode to emit light at said determined intensity level.

18. A system for measuring particle concentration wherein said system including:
a first photon generator wherein said first photon generator is positioned at a first generator location wherein said first photon generator is fixed at said first generator location wherein said first photon generator emits light;
a first photon sensor wherein said first photon sensor is positioned at a first sensor location wherein said first photon sensor is fixed at said first sensor location wherein said first photon sensor detects said light emitted from said first photon generator wherein said first photon sensor measures the amount of photon energy of said detected light;
a second photon sensor wherein said second photon sensor is positioned at a second sensor location wherein said second photon sensor is fixed at said second sensor location wherein said second photon sensor detects said light emitted from said first photon generator wherein said second photon sensor measures the amount of photon energy of said detected light; and
a main controller receiving first data from said first photon sensor wherein said main controller is in connection with said first photon sensor wherein said first data represents said amount of photon energy measured by said first photon sensor,
receiving second data from said second photon sensor wherein said main controller is in connection with said second photon sensor wherein said second data represents said amount of photon energy measured by said second photon sensor,
determining first particle concentration wherein said main controller determines said first particle concentration based on said first data wherein said first particle concentration is determined in proportion to said amount of photon energy represented by said first data,
determining second particle concentration wherein said main controller determines said second particle concentration based on said second data wherein said second particle concentration is determined in proportion to said amount of photon energy represented by said second data.

19. The system of claim 18 further including:
a second photon generator wherein said second photon generator is positioned at a second generator location wherein said second photon generator is fixed at said second generator location wherein said second photon generator emits light.

20. The system of claim 19 wherein said first photon sensor and said second photon sensor detect said light emitted from said second photon generator.

21. The system of claim 19 wherein one of said first photon sensor and said second photon sensor detect said light emitted from said second photon generator.

22. The system of claim 18 wherein said photon sensor is composed of at least one sensory array wherein said sensory array is composed of a plurality of light sensors.

23. The system of claim 22 wherein a center-to-center spacing between said plurality of light sensors is less than 1.26 mm.

24. The system of claim 22 wherein said plurality of light sensors of said sensory array is arranged in a linear array form.

25. The system of claim 18 wherein said system is applied to calculate the velocity of particles moving from said first sensor location to said second sensor location.
